(19) United States
(12) Patent Application Publication
(10) Pub. No.: US 2021/0016439 A1
(43) Pub. Date: Jan. 21, 2021

(54) LEARNING DEVICE, ROBOT CONTROL SYSTEM, AND LEARNING CONTROL METHOD

(71) Applicant: KYOCERA Document Solutions Inc., Osaka (JP)

(72) Inventor: Masato KOZUKA, Osaka-shi (JP)

(73) Assignee: KYOCERA Document Solutions Inc., Osaka (JP)

(21) Appl. No.: 16/930,623

(22) Filed: Jul. 16, 2020

(30) Foreign Application Priority Data
Jul. 18, 2019 (JP) 2019-132767

(51) Int. Cl. B25J 9/16; G06T 7/00

(52) U.S. Cl. CPC B25J 9/163; G06T 2207/20081; B25J 9/1697; G06T 7/0004

(57) ABSTRACT

A learning device includes storage and a learning section. The storage stores therein a learning model. The learning model causes the learning model to learn training data including captured image data and gripping force data. The captured image data corresponds to data to be input to the learning model. The gripping force data corresponds to data to be output from the learning model. The captured image data is data generated by capturing an image of a work to be gripped by a robotic device. The gripping force data is data indicating a gripping force of the robotic device when gripping the work.

### INCORPORATION BY REFERENCE

The present application claims priority under 35 U.S.C. § 119 to Japanese Patent Application No. 2019-132767, filed on Jul. 18, 2019. The contents of this application are incorporated herein by reference in their entirety.

### BACKGROUND

The present disclosure relates to a learning device, a robot control system, and a learning control method.

A manipulator includes a hand support, finger linkage mechanisms, and arm linkage mechanisms, and an input and output section. The hands work according to an operator instruction. The hand support includes a head, arms, and fingers. A head linkage mechanism detects a position and an orientation of a headgear section that an operator wears. The finger linkage mechanisms are worn on fingers of both hands of the operator, and detect respective positions and orientations of the fingers. The arm linkage mechanisms are worn on hands of the operator, and detect respective positions and orientations of arms of the operator. The input and output section teaches the positions and the orientations of the hands based on respective detection results by the finger linkage mechanisms and respective detection results by the arm linkage mechanisms. The operator operating the hands of the manipulator enables teaching of the manipulator.

### SUMMARY

A learning device according to a first aspect of the present disclosure includes storage and a learning section. The storage stores therein a learning model. The learning section causes the learning model to learn training data that includes captured image data corresponding to data to be input to the learning model, and gripping force data corresponding to data to be output from the learning model. The captured image data is data generated by capturing an image of a work to be gripped by a robotic device. The gripping force data is data indicating a gripping force of the robotic device when gripping the work.

A robot control system according to a second aspect of the present disclosure includes a robotic device and a robot control device. The robotic device includes a gripping section. The gripping section grips a work. The robot control device includes an imaging section, storage, and a gripping controller. The imaging section captures an image of the work before the gripping section grips the work, and generates captured image data representing the image of the work. The storage stores therein a learning model trained. The learning model is generated by machine learning. The gripping controller controls the gripping section. The gripping controller inputs the captured image data to the learning model to cause the learning model to output gripping force data, and controls the gripping section so that the gripping section generates a gripping force that is indicated by the gripping force data output from the learning model. The gripping force data is data indicating the gripping force of the robotic device when gripping the work.

A learning control method according to a third aspect of the present disclosure includes inputting to a learning model and causing the learning model to learn. The inputting to the learning model includes inputting training data to the learning model. The training data includes captured image data corresponding to data to be input to the learning model, and gripping force data corresponding to data to be output from the learning model. The causing the learning model to learn includes causing the learning model to learn the training data. The captured image data is data generated by capturing an image of a work to be gripped by a robotic device. The gripping force data is data indicating a gripping force of the robotic device when gripping the work.

### BRIEF DESCRIPTION OF THE DRAWINGS

FIG. 1 illustrates a robot control system according to a first embodiment of the present disclosure.

FIG. 2 is a structural block diagram of a robot control device in the first embodiment.

FIG. 3 schematically illustrates a process of causing a learning model in the first embodiment to output gripping force data.

FIG. 4 is a flowchart depicting a process of gripping a work in the first embodiment. FIG. 5 illustrates a learning device that generates the learning model in the first embodiment.

FIG. 6A illustrates training data.

FIG. 6B illustrates training data different from the training data illustrated in FIG. 6A.

FIG. 6C illustrates training data different from the training data illustrated in FIG. 6A and the training data illustrated in FIG. 6B.

FIG. 7 is a flowchart depicting a process of causing the learning model to learn the training data in the first embodiment.

FIG. 8 illustrates a structure of a robot control system according to a second embodiment of the present disclosure.

FIG. 9A schematically Illustrates gripping force data output from a learning model in the second embodiment.

FIG. 9B is a schematic illustration depicting additional training data used for additional learning in the second embodiment.

FIG. 10 is a flowchart depicting an additional learning process executed by a controller in the second embodiment.

FIG. 11 illustrates a structure of a robot control system according to a third embodiment of the present disclosure.

FIG. 12 illustrates a learning device that generates a first learning model and a second learning model in the third embodiment.

FIG. 13 is a flowchart depicting a first learning process executed by a controller in the second embodiment.

FIG. 14 is a flowchart depicting a second learning process executed by the controller in the third embodiment.

### DETAILED DESCRIPTION

Embodiments of the present disclosure will hereinafter be described with reference to the accompanying drawings. Elements that are the same or equivalent are labelled with the same reference signs in the drawings and description thereof is not repeated.

### First Embodiment

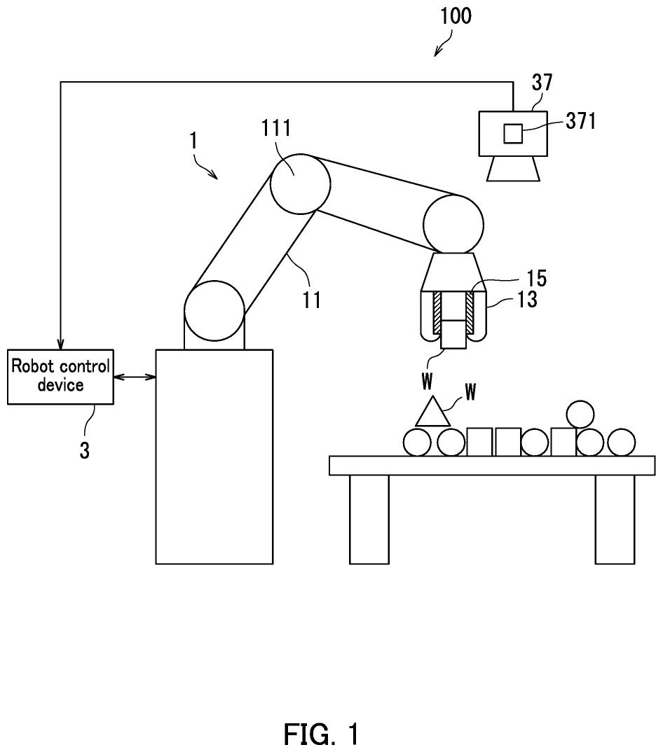

A robot control system 100 according to a first embodiment will first be described with reference to FIG. 1. As an example in the present embodiment, the robot control system 100 performs vision picking.

FIG. 1 illustrates the robot control system 100 according to the present embodiment. The robot control system 100 includes a robotic device 1 and a robot control device 3. The robotic device 1 grips a work W. Specifically, the robotic device 1 repeats an operation of gripping (picking) the work W, conveying the work W to a predetermined position, and then placing the work W thereon.

The robotic device 1 includes an articulated arm 11, a hand 13, and a gripping force sensor 15. The articulated arm 11 includes joint axes 111. A torque sensor, a motor, and an encoder are located with respect to each of the joint axes 111. Each of the torque sensors provided for the joint axes 111 detects torque applied to a corresponding joint axis 111 to transmit a detection result to the robot control device 3. Each joint axis 111 is driven by a corresponding motor. The encoder provided for each joint axis 111 detects angle information of a corresponding joint axis 111 to transmit a detection result to the robot control device 3.

The hand 13 is placed at the end of the articulated arm 11. A position and posture of the hand 13 is changed as a result of the articulated arm 11 being driven. The hand 13 performs opening and closing operation to grip the work W. The hand 13 grips the work W for example by opening and closing fingers thereof. The hand 13 is for example an end effector. The hand 13 corresponds to an example of a “gripping section”.

The hand 13 repeats an operation of gripping (picking) the work W, conveying the work W to a predetermined position, and then placing the work W thereon. The work W is for example food. Alternatively, the work W may be for example one of parts for an image forming apparatus.

The gripping force sensor 15 detects a gripping force of the hand 13 when the hand 13 grips the work W, and then transmits a gripping force signal indicating the gripping force to the robot control device 3. The gripping force sensor 15 is for example a pressure sensor. In this case, the pressure sensor is mounted on a finger of the hand 13. The pressure sensor detects a pressure to the work W when the hand 13 grips the work W, and then transmits a pressure detection signal indicating the pressure as a gripping force signal to the robot control device 3.

Note that the gripping force sensor 15 may be for example a force-sensing sensor. In this case, the force-sensing sensor is mounted on the hand 13. The force-sensing sensor detects a reaction force from the work W when the hand 13 grips the work W, and then transmits a reaction force detection signal indicating the reaction force as a gripping force signal to the robot control device 3. The force-sensing sensor is for example a 6-axis force sensor and detects respective forces on an X-axis, a Y-axis, and a Z-axis, and respective moments about the axes.

The robot control device 3 controls the robotic device 1. The robot control device 3 includes an imaging section 37.

The imaging section 37 captures an image of the work W that is a target to be gripped by the robotic device 1, and then generates captured image data containing the image of the work W. The imaging section 37 captures for example an image of the work W before the robotic device 1 grips the work W, and generates captured image data representing the image of the work W. The imaging section 37 transmits the captured image data to the robot control device 3 by wired communication or wireless communication. In the present embodiment, the imaging section 37 captures respective images of works W that are identical to or different from each other, and generates captured image containing the respective images representing the works W. The imaging section 37 is placed above the works W. Note that as long as the imaging section 37 can capture the images of the works W, the position of the imaging section 37 may be placed on the hand 13 for example, and is not particularly limited. In addition, the captured image data may be moving image data or still image data.

Specifically, the imaging section 37 includes a camera 371. The camera 371 captures an image of the work W to generate captured image data containing the image representing the work W. In the present embodiment, the camera 371 captures respective images of the works W to generate captured image data containing the respective images representing the works W. Each image is for example an RGB (red, green, blue) image. Examples of the camera 371 include a complementary metal oxide semiconductor (CMOS) image sensor and a charge coupled device (CCD) image sensor.

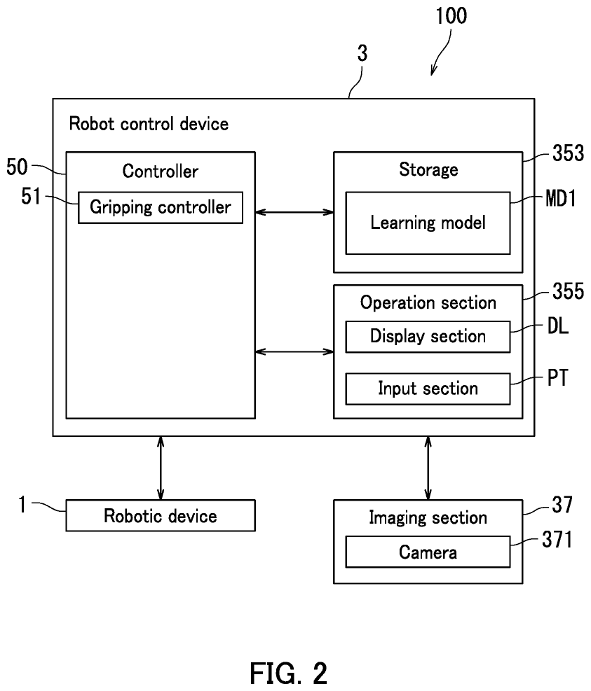

The robot control device 3 will next be described in detail with reference to FIG. 2. FIG. 2 is a structural block diagram of the robot control device 3. The robot control device 3 includes storage 353, an operation section 355, and a controller 50.

The operation section 355 allows a user to enter an operation therethrough. Specifically, the operation section 355 includes a display section DL and an input section PT. The display section DL displays an image. The display section DL is a display. Examples of the display include a liquid-crystal display and an organic electroluminescent display. The input section PT allows the user to enter an input therethrough. In the present embodiment, the input section PT is a touch panel that allows the user to enter a touch input therethrough. For example, the touch panel allows the user to enter therethrough a touch input by a finger of the user or a touch input by a stylus gripped by the user. The touch panel is arranged on a display surface of the display in a pile. Note that examples of the input section PT may include a keyboard and a pointing device.

The storage 353 includes a storage device. The storage device stores therein data and computer programs. Specifically, the storage device includes a main storage device such as semiconductor memory, and an auxiliary storage device. Examples of the auxiliary storage device include semiconductor memory, a solid state drive, and a hard disk drive.

The storage 353 stores therein a learning model MD1 trained. The learning model MD1 is generated by machine learning. Captured image data PD is input to the learning model MD1, and thereby the learning model MD1 outputs gripping force data GD. The captured image data PD is data representing an image of the work W generated by capturing an image of the work W before the hand 13 grips the hand 13. The gripping force data GD is data representing a gripping force of the robotic device 1 when gripping the work W.

The controller 50 includes a processor and a storage device. The processor includes for example a central processing unit (CPU) and a graphics processing unit (GPU). The storage device stores therein data and a computer program. Specifically, the storage device of the controller 50 includes a main storage device such as semiconductor memory, and an auxiliary storage device. Examples of the auxiliary storage device include semiconductor memory, a solid state drive, and a hard disk drive. The processor of the controller 50 executes the computer program stored in the storage 353, thereby controlling each of constituent elements of the robotic device 1.

The controller 50 of the robot control device 3 will subsequently be described in detail with reference to FIGS. 1 and 2. The controller 50 includes a gripping controller 51. The processor of the controller 50 executes the computer program stored in the storage 353, thereby functioning as the gripping controller 51.

The gripping controller 51 controls the hand 13. Specifically, the gripping controller 51 inputs the captured image data PD to the learning model MD1, thereby causing the learning model MD1 to output the gripping force data GD. The gripping controller 51 then controls the hand 13 so that the hand 13 generates a gripping force indicated by the gripping force data GD output from the learning model MD1. The robotic device 1 therefore does not need teaching of a gripping force corresponding to the work W every time the work W is changed. As a result, it is possible to suppress teaching to the robotic device 1 on the site and reduce the burden on the site.

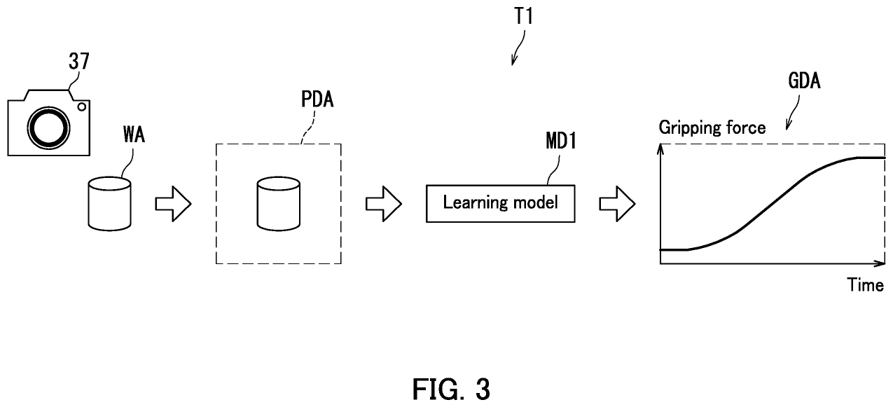

An output process T1 in which the learning model MD1 outputs the gripping force data GD will next be described with reference to FIG. 3. FIG. 3 schematically illustrates the output process T1 in which the learning model MD1 outputs the gripping force data GD. For example, the gripping controller 51 inputs the captured image data PD to the learning model MD1 to cause the learning model MD1 to output the gripping force data GD. Specifically, as illustrated in FIG. 3, the gripping controller 51 inputs captured image data PDA to the learning model MD1 to cause the learning model MD1 to output gripping force data GDA.

In the output process T1 illustrated in FIG. 3, the controller 50 controls the imaging section 37 so that the imaging section 37 captures an image of a work WA before the hand 13 grips the work WA, and then generates the captured image data PDA representing the image of the work WA. The work WA is a target to be gripped by the robotic device 1. The work WA is a cylindrical work. The captured image data PDA contains image data representing the image of the work WA.

The gripping controller 51 then inputs the captured image data PDA to the learning model MD1. The captured image data PDA is input to the learning model MD1, whereby the learning model MD1 outputs the gripping force data GDA illustrated in FIG. 3. The gripping force data GDA output from the learning model MD1 indicates a gripping force of the robotic device 1 when gripping the work WA.

In addition, as illustrated in FIG. 3, the gripping force data GDA output from the learning model MD1 indicates a change over time in a gripping force. It is therefore possible to control the robotic device 1 based on the change over time in the gripping force. From the change over time in the gripping force, it is consequently possible to precisely control the hand 13 when gripping the work W.

In addition, as illustrated in FIG. 3, the gripping force data GDA output from the learning model MD1 indicates a change over time until the gripping force increases from an initial value and then becomes substantially constant. It is therefore possible to determine timing of gripping the work W and an amount of a force applied to the work W after the hand 13 starts gripping the work W. As a result, the precision of controlling a hand section is further improved.

As illustrated in FIG. 1, when the robotic device 1 grips the works W to convey the works W to a predetermined position one at a time, the imaging section 37 captures an image of a work W to be gripped by the hand 13. The gripping controller 51 then inputs the captured image data PD generated by the imaging section 37 to the learning model MD1. The learning model MD1 then outputs the gripping force data GD. The gripping controller 51 then controls the hand 13 based on the gripping force data GD. The robotic device 1 can therefore grip the work W with an appropriate force and place the work W at the predetermined position. Even if the work W has a shape different from that of a work W placed, the gripping force data GD corresponding to the work W is output as a result of the gripping controller 51 inputting the captured image data PD generated by the imaging section 37 to the learning model MD1. Therefore, even when a work W is included in different types of works W, the work can be gripped with an output gripping force.

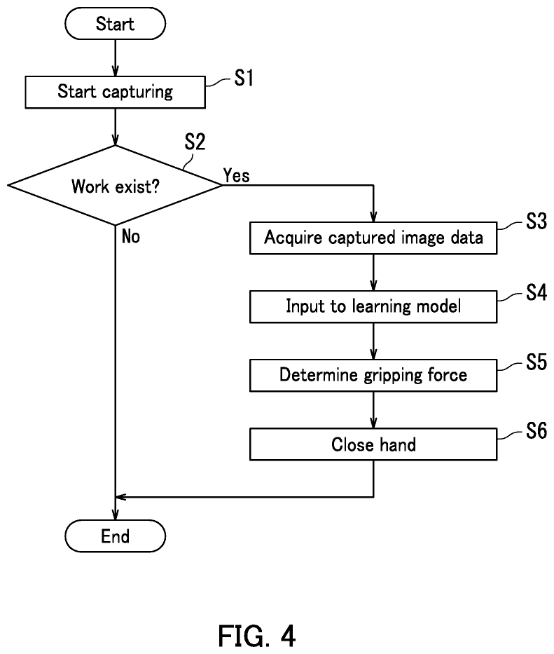

A process in which the hand 13 grips a work W based on gripping force data GD output in the output process T1 will next be described with reference to FIG. 4. FIG. 4 is a flowchart depicting a process of gripping the work W. The process of gripping the work W illustrated in FIG. 4 includes Steps S1 to S6. That is, Steps S1 to S6 constitute part of a robot control method for controlling the robotic device 1.

In Step S1, the controller 50 controls the imaging section 37 so that the imaging section 37 starts to capture an image of the work W. The process proceeds to Step S2.

In Step S2, the controller 50 determines whether or not the work W exits based on the captured image data PD. If it is determined that the work W does not exist in Step S2 (No in Step S2), the process ends. In contrast, if it is determined that the work W exists in Step S2 (Yes in Step S2), the process proceeds to Step S3.

If Yes in Step S2, the controller 50 acquires the captured image data PD containing the image of the work W from the imaging section 37 in Step S3. The process then proceeds to Step S4.

In Step S4, the gripping controller 51 inputs the captured image data PD to the learning model MD1 to cause the learning model MD1 to output the gripping force data GD. The process then proceeds to Step S5.

In Step S5, the gripping controller 51 determines a gripping force based on the gripping force data GD output from the learning model MD1. Here, the gripping force is a gripping force of the hand 13 when the hand 13 grips the work. The process then proceeds to Step S6.

In Step S6, the gripping controller 51 controls the hand 13 so that the hand 3 is being closed until the gripping force of the hand 13 gripping the work W reaches the determined gripping force. The process then ends.

A learning device 200 that generates the learning model MD1 will next be described with reference to FIG. 5. FIG. 5 illustrates the learning device 200 that generates the learning model MD1. As illustrated in FIG. 5, the learning device 200 includes a controller 230, an operation section 261, and storage 250.

The controller 230 includes a processor and a storage device. The processor of the controller 230 includes for example a CPU and a GPU. The processor of the controller 230 executes a computer program stored in the storage device of the controller 230, thereby controlling the operation section 261 and the storage 250.

The operation section 261 allows the user to enter an operation therethrough. The operation section 261 includes a display section 262 and an input section 263. The display section 262 displays an image. The display section 262 is a display. The input section 263 allows the user to enter an input therethrough. The input section 263 includes a keyboard and a pointing device. The input section 263 may be a touch panel.

In the present embodiment, teaching of the robotic device 1 is possible by causing the display section 262 to display an image of the robotic device 1 and an image of the work W. For example, the display section 262 displays a 3D image of the robotic device 1 and a 3D image of the work W. That is, the teaching of the robotic device 1 is possible in a virtual space.

The 3D image of the work W is generated based on image data representing an image of the work W. Characteristics of the work W are set to the work W in the virtual space. The characteristics of the work W include a material of the work W, a shape of the work W, surface roughness of the work W, a size of the work W, weight of the work W, hardness of the work W, elasticity of the work W and the like. A material of the hand 13, a shape of the hand 13, a size of the hand 13 and the like are set to the hand 13 of the robotic device 1 in the virtual space. It is therefore possible to collect the gripping force data GD for the work W as in the case where the hand 13 of the robotic device 1 actually grips the work W.

The image data representing the image of the work W used for the teaching is transmitted as the captured image data PD to the controller 230. In addition, a gripping force of the hand 13 of the robotic device 1 when the hand 13 grips the work W is transmitted as the gripping force data GD to the controller 230.

The storage 250 includes a storage device. The storage device of the storage 250 stores therein data and computer programs. Specifically, the storage device of the storage 250 includes a main memory device such as semiconductor memory, and an auxiliary storage device. Here, examples of the auxiliary storage device include semiconductor memory, a solid state drive, and a hard disk drive. The storage 250 stores therein the learning model MD1 and pieces of training data TD.

A learning model MD is a learning model not trained or a learning model being trained.

The pieces of training data TD are to be input to the learning model MD. Each piece of training data TD contains captured image data PD and gripping force data GD. Here, the captured image data PD is associated with the gripping force data GD.

A structure of the controller 230 will subsequently be described with reference to FIG. 5. The controller 230 includes a training data generating section 201 and a learning section 202. The processor of the controller 230 executes a computer program stored in the storage device of the controller 230, thereby functioning as the training data generating section 201 and the learning section 202.

The training data generating section 201 generates training data TD to be learned by the learning model MD. The training data TD is a data set including captured image data PD and gripping force data GD. Specifically, the training data generating section 201 generates the training data TD in which the captured image data PD is associated with the gripping force data GD.

The learning section 202 causes the learning model MD to learn the training data TD. The learning section 202 causes the learning model MD to learn the training data TD, thereby generating a learning model MD1 trained. The captured image data PD included in the training data TD corresponds to input data of the learning model MD1. The gripping force data GD included in the training data TD corresponds to output data of the learning model MD1.

A machine learning algorithm that generates the learning model MD1 is not particularly limited as long as it is supervised learning, and examples thereof include a decision tree, a nearest neighbor method, a naive Bayes classifier, a support vector machine, and a neural network. The learning model MD1 therefore includes the decision tree, the nearest neighbor method, the naive Bayes classifier, the support vector machine, or the neural network. An error backpropagation method may be used for the machine learning for generating the learning model MD1.

In the present embodiment, the machine learning algorithm that generates the learning model MD1 is a neural network. That is, the learning model MD1 includes the neural network. The neural network includes an input layer, one or more intermediate layers, and an output layer. Preferably, the neural network is a deep neural network (DNN), a recurrent neural network (RNN), or a convolutional neural network (CNN), and performs deep learning.

The deep neural network includes an input layer, intermediate layers, and an output layer. The convolutional neural network includes an input layer, convolutional layers, pooling layers, a fully connected layer, and an output layer. In the convolutional neural network, the convolutional layers and the pooling layers are alternately arranged between the input layer and the fully connected layer.

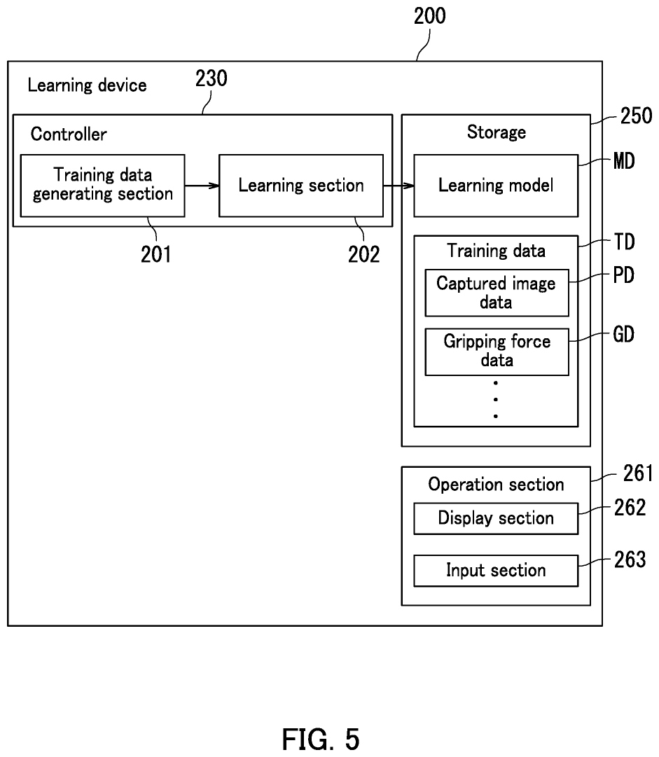

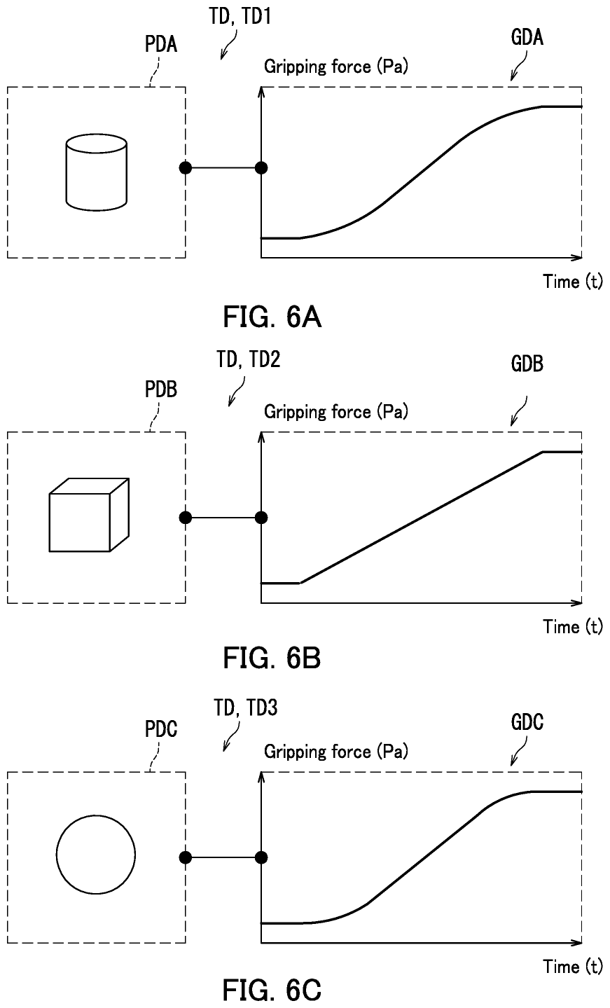

The pieces of training data TD stored in the storage 250 will next be described with reference with FIGS. 6A to 6C. For example, as illustrated in FIGS. 6A to 6C, the storage 250 stores therein the pieces of training data TD. The pieces of training data TD include for example training data TD1, training data TD2, and training data TD3.

FIG. 6A illustrates the training data TD1. The training data TD1 includes the captured image data PDA and the gripping force data GDA. The captured image data PDA includes the image data representing an image of a work WA. The work WA is a cylindrical work. The gripping force data GDA indicates a gripping force of the hand 13 when gripping the work WA. The gripping force data GDA is expressed by a gripping force (Pa) and time (t). That is, the gripping force data GDA includes a change over time in the gripping force. The gripping force data GDA indicates a change over time until the gripping force increases from an initial value and then becomes substantially constant.

FIG. 6B illustrates the training data TD2 different from the training data TD1 illustrated in FIG. 6A. The training data TD2 includes captured image data PDB and gripping force data GDB. The captured image data PDB includes image data representing an image of a work WB. The work WB is a square columnar work. The gripping force data GDB indicates a gripping force of the hand 13 when gripping the work WB. The gripping force data GDB is expressed by a gripping force (Pa) and time (t).

FIG. 6C illustrates the training data TD3 different from the training data TD1 illustrated in FIG. 6A and the training data TD2 illustrated in FIG. 6B. The training data TD3 includes captured image data PDC and gripping force data GDC. The captured image data PDC includes image data representing an image of a work WC. The work WB is a spheroidal work. The gripping force data GDC is data indicating a gripping force of the hand 13 when gripping the work WC. The gripping force data GDC is expressed by a gripping force (Pa) and time (t).

Note that a work W of the training data TD is not limited to only a work W handled by the robotic device 1 on site. A work W not handled on site may be learned. The learning model MD learns various works W, thereby enabling estimation of a gripping force of a work W not learned.

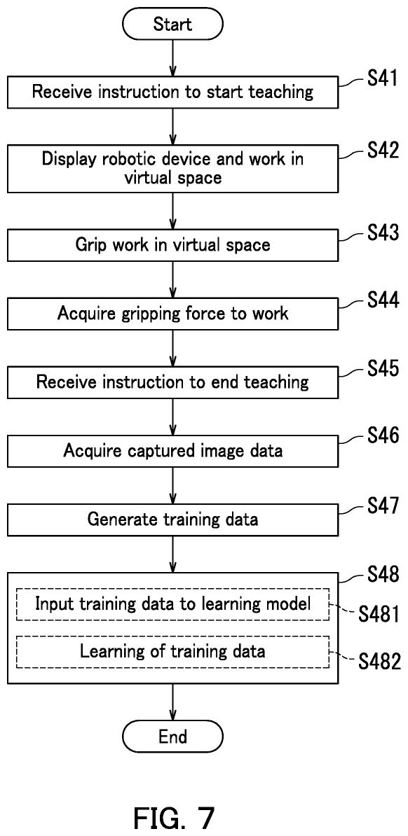

A process of causing the learning model MD to learn the training data TD will next be described with reference to FIG. 7. FIG. 7 is a flowchart depicting the process of causing the learning model MD to learn the training data TD. The process illustrated in FIG. 7 includes Steps S41 to S48.

In Step S41, the controller 230 receives, from the operation section 261, a signal indicating that an instruction to the controller 230 to start teaching of the robotic device 1 has been received. The process then proceeds to Step S42.

In Step S42, the controller 230 controls the display section 262 so that the display section 262 displays an image of the robotic device 1 and an image of a work W in a virtual space. The process then proceeds to Step S43.

In Step S43, the controller 230 controls the hand 13 displayed on the display section 262 so that the hand 13 grips the work W in the virtual space. The process then proceeds to Step S44.

In Step S44, the controller 230 acquires gripping force data GD for the work W. Specifically, the controller 230 acquires the gripping force data GD indicating a gripping force of the hand 13 when the hand 13 gripped the work W. The process then proceeds to Step S45.

In Step S45, the controller 230 receives, from the operation section 261, a signal indicating that an instruction to the controller 230 to end the teaching of the robotic device 1 has been received. The process then proceeds to Step S46.

In Step S46, the controller 230 acquires captured image data PD. The process then proceeds to Step S47.

In Step S47, the training data generating section 201 generates training data TD in which the captured image data PD is associated with the gripping force data GD. The process then proceeds to Step S48.

In Step S48, the learning section 202 inputs the training data TD to the learning model MD to cause the learning model MD to perform learning. Specifically, Step S28 includes Step S481 and Step S482. In Step S481, the learning section 202 inputs the training data TD to the learning model MD. In Step S482, the learning model MD learns the input training data TD. The process then ends.

### Second Embodiment

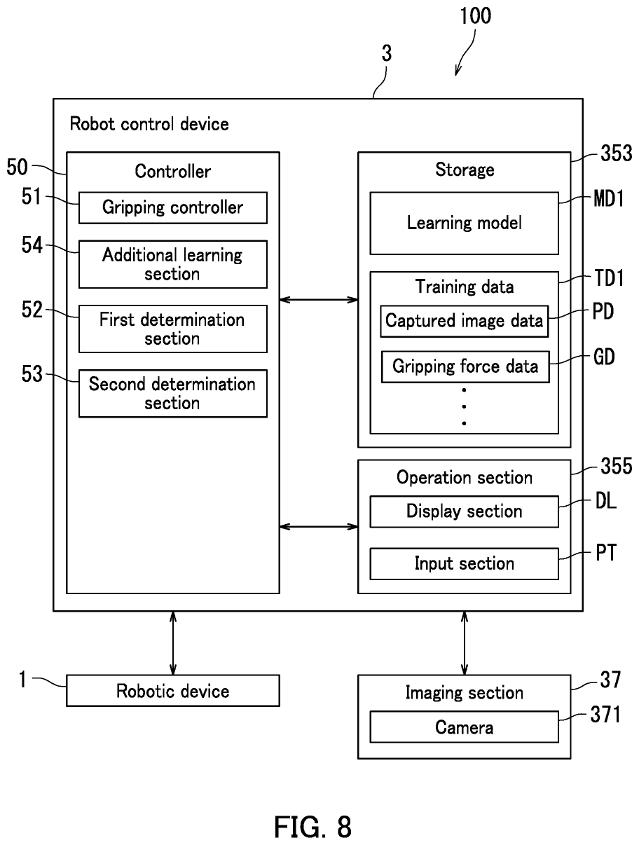

A robot control system 100 according to a second embodiment will next be described with reference to FIG. 8. The robot control system 100 according to the second embodiment differs from the robot control system 100 according to the first embodiment in that a robot control device 3 thereof includes an additional learning section 54, a first determination section 52, and a second determination section 53. Matters of the second embodiment different from those of the first embodiment will hereinafter be described, and description of matters overlapping with those of the first embodiment will be omitted. FIG. 8 illustrates a structure of the robot control system 100 according to the second embodiment.

A controller 50 further includes the first determination section 52, the second determination section 53, and the additional learning section 54. The controller 50 executes a control program, thereby functioning as the first determination section 52, the second determination section 53, and the additional learning section 54.

The first determination section 52 determines whether or not a work W has successfully been gripped. Specifically, the first determination section 52 determines whether or not the work W has successfully been gripped based on a detection result by a gripping force sensor 15. The first determination section 52 can therefore determine whether or not the work W has successfully been gripped based on gripping force data GD output from a learning model MD 1. It is consequently possible to determine whether or not a gripping force of a hand 13 when gripping the work W has been appropriate.

For example, when the hand 13 has successfully gripped the work W, the hand 13 can lift up the work W. When the hand 13 successfully lifts up the work W, a pressure detected by the gripping force sensor 15 increases. A value detected by the gripping force sensor 15 subsequently becomes constant. Thus, the first determination section 52 determines that the work W has successfully been gripped when the pressure detected by the gripping force sensor 15 increases and then becomes constant.

In contrast, when the hand 13 has failed to grip the work W, the hand 13 cannot lift up the work W. When the hand 13 fails to lift up the work W, the pressure detected by the gripping force sensor 15 increases. A value detected by the gripping force sensor 15 subsequently decreases. Thus, the first determination section 52 determines that the hand 13 has failed to grip the work W when the pressure detected by the gripping force sensor 15 increases and then decreases. An operator who has confirmed a determination result by the first determination section 52 can understand that the gripping force data GD output from the learning model MD1 has been appropriate to gripping the work W.

In addition, when the first determination section 52 determines that the hand 13 has failed to grip the work, storage 353 stores therein captured image data PD representing an image of the work W when the hand 13 has failed to grip the work W, and gripping force data GD indicating a gripping force of the hand 13 when having failed to grip the work W.

The operator of a robotic device 1 then causes the controller 50 to generate corrected gripping force data GD by which the hand 13 can grip the work W that the hand 13 has failed to grip, based on the captured image data PD and the gripping force data GD. Here, the captured image data PD is stored in the storage 353 and represents the image of the work W that the hand 13 has failed to grip. The gripping force data GD is stored in the storage 353 and indicates the gripping force of the hand 13 when having failed to grip the work W. The corrected gripping force data GD is input to the robot control device 3. The controller 50 generates additional training data TD in which the captured image data PD representing the image of the work W when the hand 13 has failed to grip is associated with the corrected gripping force data GD.

The second determination section 53 determines whether or not the shape of the work W has changed. Specifically, the second determination section 53 determines whether or not the work W is deformed based on captured image data obtained by capturing an image of the work W before the work W is gripped by the hand 13, and captured image data obtained by capturing an image of the work W after the work W is gripped by the hand 13. The work W being deformed means the shape of the work W having changed. Examples of the shape of the work W having changed include the work W having a dent, and the work having been destroyed.

When the second determination section 53 determines that the work W is not deformed, the gripping force of the hand 13 when gripping the work W is appropriate. That is, the gripping force data GD output from the learning model MD1 is appropriate. In contrast, when the second determination section 53 determines that the work W is deformed, the gripping force of the hand 13 when gripping the work W is inappropriate. That is, the gripping force data GD output from the learning model MD1 is inappropriate.

When the second determination section 53 determines that the work W is deformed, the controller 230 causes the storage 353 to store therein captured image data PD representing the image of the work W deformed by the hand 13, and gripping force data indicating the gripping force of the hand 13 when the work W is deformed.

The operator of the robotic device 1 then generates the corrected gripping force data GD indicating a corrected gripping force of the hand 13 not to deform the work W, based the captured image data PD and the gripping force data GD. The captured image data PD is stored in the storage 353 and represents the image of the work W deformed by the hand 13. The gripping force data is stored in the storage 353 and indicates the gripping force of the hand 13 when the work W is deformed. The controller 50 further generates additional training data TD in which captured image data PD obtained by capturing an image of the work W before the work W is deformed is associated with the corrected gripping force data GD.

The additional learning section 54 causes the learning model MD1 to additionally learn training data TD including captured image data PD and corrected gripping force data GD. The captured image data PD is for example the captured image data PD representing the image of the work W that the hand 13 has failed to grip. The corrected gripping force data GD is the gripping force data GD corrected based on the captured image data PD representing the image of the work W that the hand 13 has failed to grip. The captured image data PD is for example captured image data representing the image of the work W before the work W is deformed. The corrected gripping force data GD is for example the gripping force data GD corrected based on the captured image data PD representing the image of the work W before the work W is deformed.

It is therefore possible to cause the learning model MD1 to additionally learn using the training data TD for additional learning at a site where the robotic device 1 is placed. As a result, the learning model MD1 can be tuned according to the site where the robotic device 1 is placed.

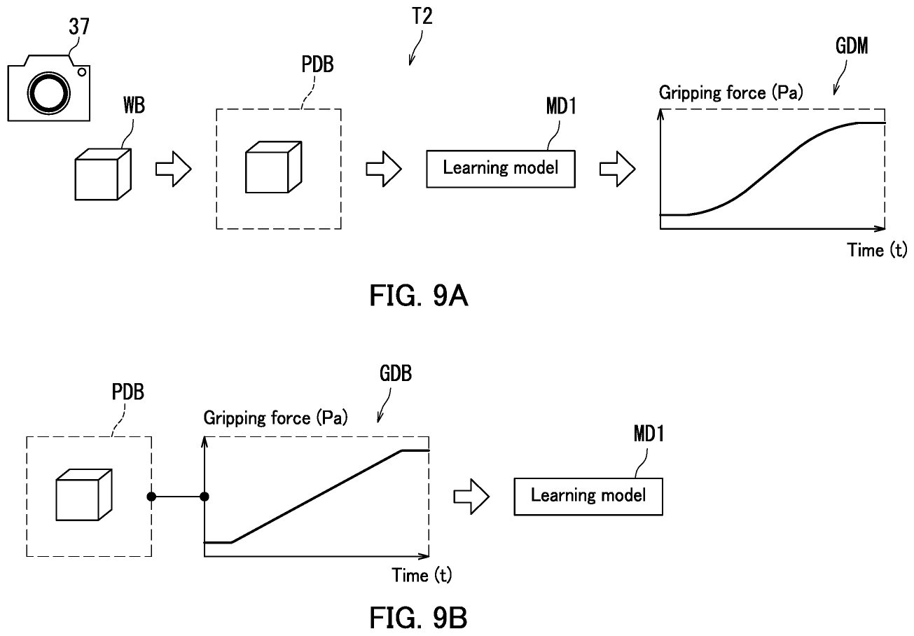

A generating process T2 of generating the training data TD for causing the learning model MD1 to perform additional learning will next be described with reference to FIGS. 9A and 9B. FIGS. 9A and 9B schematically illustrate the generating process T2 of the learning model MD1.

FIG. 9A schematically illustrates the gripping force data GD output from the learning model MD1 in the second embodiment. As illustrated in FIG. 9A, the controller 50 controls an imaging section 37 so that the imaging section 37 captures an image of the hand 13 in a gripping operation and a work WB in the gripping operation. The imaging section 37 then generates captured image data PDB. The work WB is a target to be gripped by the robotic device 1. The captured image data PDB includes image data representing the image of the work WB. FIG. 9B is a schematic illustration depicting the additional training data TD used for the additional learning in the second embodiment. As illustrated in FIG. 9B, the learning model MD1 learns the additional training data TD.

For example, a gripping controller 51 inputs the captured image data PDB to the learning model MD1. The captured image data PDB is input to the learning model MD1, whereby the learning model MD1 outputs gripping force data GDM illustrated in FIG. 9A. The gripping force data GDM output from the learning model MD1 indicates a gripping force (Pa) of the robotic device 1 when gripping the work WB, and time (t). The gripping controller 51 determines a gripping force of the hand 13 when gripping the work WB, based on the gripping force data GDM. The gripping controller 51 then controls the hand 13 so that the hand 13 grips the work WB with the determined gripping force.

Moreover, the first determination section 52 determines whether or not the hand 13 has successfully gripped the work WB, based on a detection result by the gripping force sensor 15. If the first determination section 52 determines that the hand 13 has failed to grip the work WB, the controller 50 determines to cause the learning model MD1 to perform additional learning.

If it is determined to cause the learning model MD1 to perform additional learning, the controller 50 generates additional training data TD illustrated in FIG. 9B. The additional training data TD illustrated in FIG. 9B is training data in which for example the captured image data PDB representing the image of the work PB that the hand 13 has failed to grip is associated with corrected gripping force data GDB. The corrected gripping force data GDB is the gripping force data GD corrected based on the captured image data PDB representing the image of the work WB that the hand 13 has failed to grip.

The additional learning section 54 then inputs the additional training data TD to the learning model MD1. The learning model MD1 learns the additional training data TD. Thus, the gripping controller 51 inputs the captured image data PDB to the learning model MD1 that has learned the additional training data TD, whereby the learning model MD1 outputs the gripping force data GDB. That is, the learning model MD1 becomes being able to output the gripping force data GDB appropriate to gripping the work WB. It is consequently possible to prevent the work WB from falling from the hand 13.

Note that the second determination section 53 may determine whether or not the shape of the work WB has changed if the first determination section 52 determines that the hand 13 has successfully gripped the work WB. Specifically, the second determination section 53 determines whether or not the work WB is deformed, based on captured image data PD obtained by capturing an image of the work WB before the work WB is gripped by the hand 13, and captured image data PD obtained by capturing an image of the work WB after the work WB is gripped by the hand 13.

If the second determination section 53 determines that the work WB is deformed, the controller 50 determines to cause the learning model MD1 to perform additional learning.

If it is determined to cause the learning model MD1 to additionally learn, the controller 50 generates the additional training data TD as illustrated in FIG. 9B. The additional training data TD illustrated in FIG. 9B is training data in which for example the captured image data PDB representing the image of the work WB before the work WB is deformed is associated with the corrected gripping force data GDB. The corrected gripping force data GDB is for example gripping force data GD corrected based on the captured image data PDB representing the image of the work W before the work W is deformed.

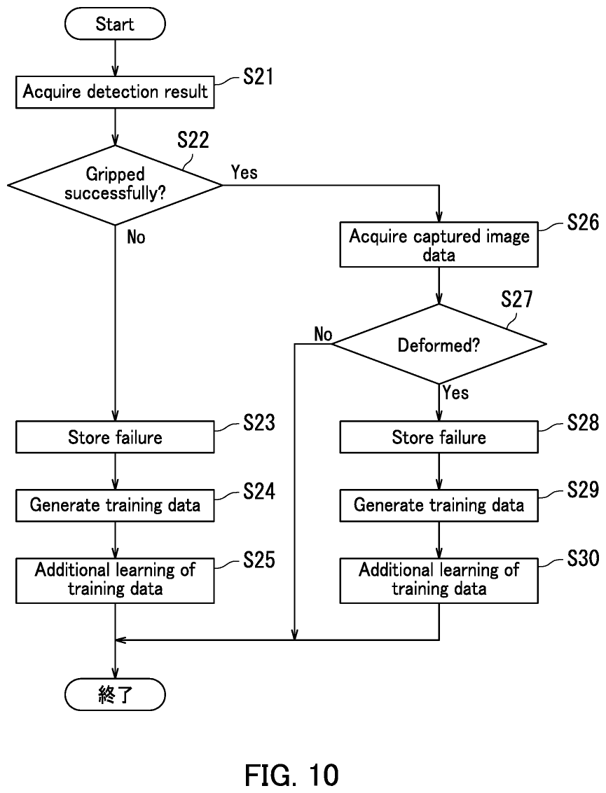

The additional learning section 54 then inputs the additional training data TD to the learning model MD1. The learning model MD1 learns the additional training data TD. Thus, the gripping controller 51 inputs the captured image data PDB to the learning model MD1 that has learned the additional training data TD, whereby the learning model MD1 outputs the gripping force data GDB. That is, the learning model MD1 becomes being able to output the gripping force data GDB appropriate to gripping the work WB. It is consequently possible to suppress deformation of the work WB. An additional learning process will next be described with reference to FIG. 10.

FIG. 10 is a flowchart depicting the additional learning process executed by the controller 50. The additional learning process executed by the controller 50 illustrated in FIG. 10 includes Steps S21 to S30. The additional learning process is carried out based on the gripping force data GD output from a learning model MD after the hand 13 grips a work W.

In Step S21, the controller 50 acquires a detection result by the gripping force sensor 15. The process then proceeds to Step S22.

In Step S22, the first determination section 52 determines whether or not the hand 13 has successfully gripped the work W based on the detection result by the gripping force sensor 15. If it is determined that the hand 13 has successfully gripped the work W (Yes in Step S22), the process proceeds to Step S26. If it is determined that the hand 13 has failed to grip the work W (No in Step S22), the process proceeds to Step S23.

If No in Step S22, the controller 50 controls in Step S23 the storage 353 so that the storage 353 stores therein captured image data PD representing the image of the work W that the hand 13 has failed to grip, and gripping force data GD indicating a gripping force of the hand 13 that has failed to grip the work W with the captured image data PD associated with the gripping force data GD. The process then proceeds to Step S24.

In Step S24, the controller 50 generates training data TD in which the captured image data representing the image of the work W that the hand 13 has failed to grip is associated with corrected gripping force data GD.

In Step S25, the additional learning section 54 causes the learning model MD1 to learn the training data TD including the captured image data PD and the corrected gripping force data GD. The process then ends.

If Yes in Step S22, the controller 50 acquires in Step S26 captured image data PD obtained by capturing an image of the work W before the work W is gripped by the hand 13, and captured image data PD obtained by capturing an image of the work W after the work W is gripped by the hand 13. The process then proceeds to Step S27.

In Step S27, the second determination section 53 determines whether or not the work W is deformed based on the acquired captured image data PD. If it is determined that the work W is not deformed (No in Step S27), the process ends. If it is determined that the work is deformed (Yes in Step S27), the process proceeds to Step S28.

If Yes in Step S27, controller 50 controls in Step S28 the storage 353 so that the storage stores therein the captured image data PD representing the image of the work W deformed by the hand 13, and the gripping force data GD indicating a gripping force of the hand 13 when the work W is deformed with the captured image data PD associated with the gripping force data GD. The process then proceeds to Step S29.

In Step S29, the controller 50 generates training data TD in which the captured image data PD obtained by capturing an image of the work W before the work W is deformed is associated with corrected gripping force data GD. The process then proceeds to Step S30.

In Step S30, the additional learning section 54 causes the learning model MD1 to additionally learn the training data TD containing the captured image data PD and the corrected gripping force data GD. The process then ends.

### Third Embodiment

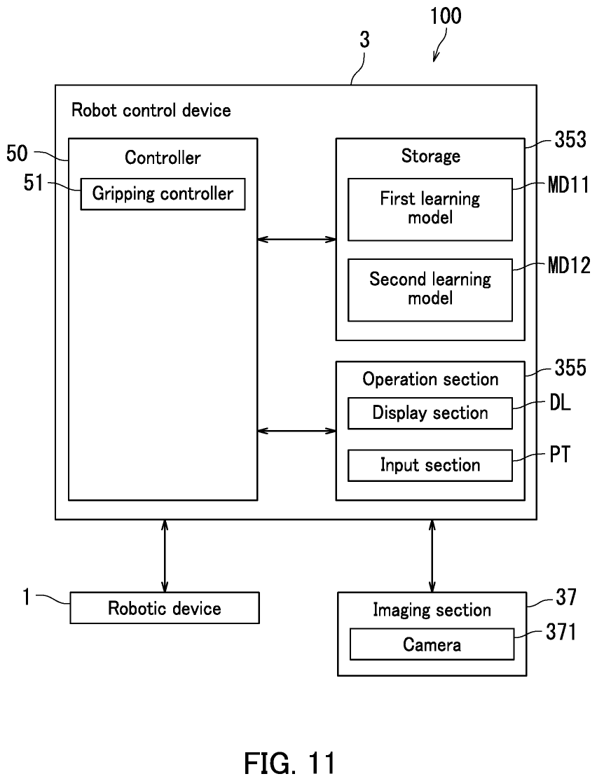

A robot control system 100 according to a third embodiment will next be described with reference to FIG. 11. The robot control system 100 according to the third embodiment differs from the robot control system 100 according to the first embodiment and the robot control system 100 according to the second embodiment in that a robot control device 3 thereof includes a first learning model MD11 and a second learning model MD21. Matters of the third embodiment different from those of the first embodiment and the second embodiment will hereinafter be described, and description of matters overlapping with those of the first embodiment and the second embodiment will be omitted.

FIG. 11 illustrates a structure of the robot control system 100 according to the third embodiment. Storage 353 in the third embodiment stores therein the first learning model MD11 and the second learning model MD21.

The first learning model MD11 is a learning model trained. Here, the learning model is generated by machine learning. The captured image data PD is input to the first learning model MD11, whereby the first learning model MD11 outputs characteristics data CD. The characteristics data CD indicates at least one of material of a work W, a shape of the work W, surface roughness of the work W, a size of the work W, weight of the work W, hardness of the work W, and elasticity of the work W.

The second learning model 21 is a learning model trained. Here, the learning model is generated by machine learning. The characteristics data CD is input to the characteristics data CD, whereby the second learning model MD21 outputs gripping force data GD.

A gripping controller 51 in the third embodiment will subsequently be described with reference to FIG. 11. The gripping controller 51 controls a hand 13. The gripping controller 51 controls the hand 13 based on the gripping force data GD.

Specifically, the gripping controller 51 inputs, to the first learning model MD11, captured image data PD representing an image of the work W captured by an imaging section 37. The gripping controller 51 acquires the characteristics data CD output from the first learning model MD11. The gripping controller 51 then inputs, to the second learning model MD21, the characteristics data CD output from the first learning model MD11. The gripping controller 51 then acquires gripping force data GD output from the second learning model MD21. The gripping controller 51 determines a gripping force of the hand 13 based on the acquired gripping force data GD. The gripping controller 51 then controls the hand 13 so that the hand 13 generates a gripping force indicated by the gripping force data GD output from the second learning model 21. A robotic device 1 therefore does not need teaching of a gripping force corresponding to the work W every time the work W is changed. It is consequently possible to suppress teaching to the robotic device 1 on site and reduce the burden on the site.

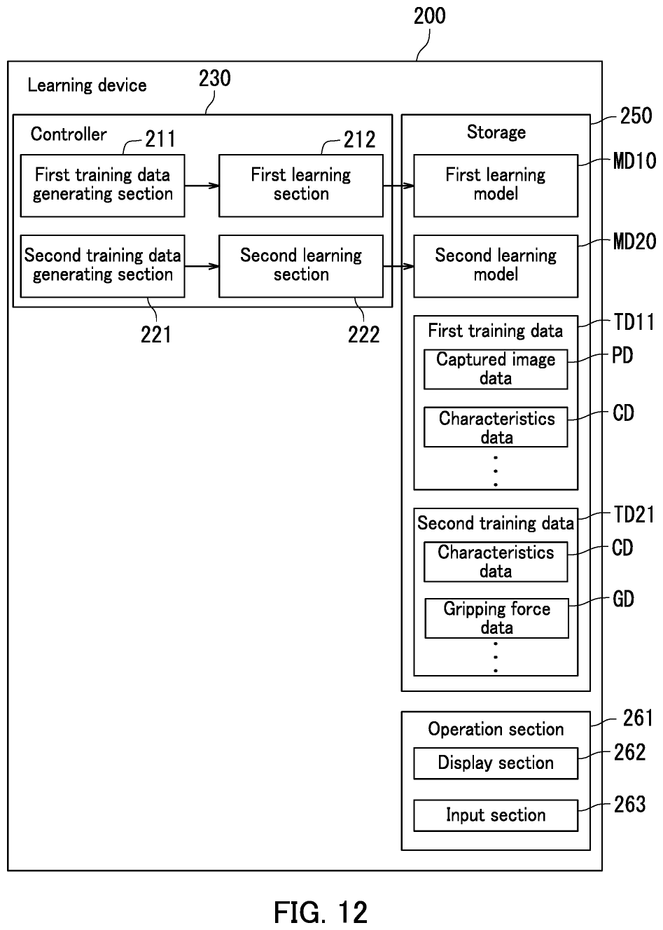

A learning device 200 that generates the first learning model MD11 and the second learning model MD21 will next be described with reference to FIG. 12. FIG. 12 illustrates the learning device 200 that generates the first learning model MD11 and the second learning model MD21. As illustrated in FIG. 12, the learning device 200 includes a controller 230, an operation section 261, and storage 250.

The controller 230 includes a processor and a storage device. The processor of the controller 230 includes for example a CPU and a GPU. The processor of the controller 230 executes a computer program stored in the storage device of the controller 230, thereby controlling the operation section 261 and the storage 250.

The operation section 261 allows a user to enter an operation therethrough. The operation section 261 includes a display section 262 and an input section 263. The display section 262 displays an image. The display section 262 is a display.

Note that teaching of the robotic device 1 is performed in a virtual space even in the present embodiment. The characteristics data CD of the work W used for teaching is therefore stored in the storage 250. In addition, a gripping force of the hand 13 of the robotic device 1 when the hand 13 grips the work W in the virtual space is stored as the gripping force data GD in the storage 250.

The storage 250 includes a storage device. The storage device of the storage 250 stores therein data and computer programs. The storage 250 stores therein a first learning model MD10, pieces of first training data TD11, a second learning model MD20, and pieces of second training data TD 21.

The first learning model MD 10 is a learning model not trained or a learning model being trained.

The pieces of first training data TD11 are each training data to be input to the first learning model MD10. Each piece of first training data TD11 includes captured image data PD and characteristics data CD. The captured image data PD is associated with the characteristics data CD.

The second learning model MD20 is a learning model not trained or a learning model being trained.

The pieces of second training data TD21 are each training data to be input to the second learning model MD20. Each piece of second training data TD21 includes characteristics data CD and gripping force data GD. The characteristics data CD is associated with the gripping force data GD.

A structure of the controller 230 will subsequently be described with reference to FIG. 12. The controller 230 includes a first training data generating section 211, a first learning section 212, a second training data generating section 221, and a second learning section 222. The processor of the controller 230 executes the computer program stored in the storage device of the controller 230, thereby functioning as the first training data generating section 211, the first learning section 212, the second training data generating section 221, and the second learning section 222.

The first training data generating section 211 generates first training data TD11 to be learned by the first learning model MD10. The first training data TD11 is a data set including captured image data PD and characteristics data CD. Specifically, the first training data generating section 211 generates training data TD in which the captured image data PD is associated with the characteristics data CD.

The first learning section 212 causes the first learning model MD10 to learn the first training data TD11. The first learning model MD10 is caused to learn the first training data TD11, whereby the first learning section 212 generates a first learning model MD11 trained. The captured image data PD included in the first training data TD11 corresponds to input data of the first learning model MD11. The characteristics data CD included in the first training data TD11 corresponds to output data of the first learning model MD11.

A machine learning algorithm for generating the first learning model MD11 is similar to the machine learning algorithm for generating the learning model MD1 of the first embodiment. In the present embodiment, the machine learning algorithm for generating the first learning model MD11 is for example a neural network. That is, the first learning model MD11 includes the neural network.

The second training data generating section 221 generates the second training data TD21 to be learned by the second learning model MD21. The second training data TD21 is a data set including characteristics data CD and gripping force data GD. Specifically, the second training data generating section 221 generates second training data TD21 in which the characteristics data CD is associated with the gripping force data GD.

The second learning section 222 causes the second learning model MD20 to learn the second training data TD21. The second learning model MD20 is caused to learn the second training data TD21, whereby the second learning section 222 generates second learning model MD21 trained. The characteristics data CD included in the second training data TD21 corresponds to input data of the second learning model MD21. The gripping force data GD included in the second training data TD21 corresponds to output data of the second training data TD21.

Note that the characteristics data CD included in the second training data TD21 may be the characteristics data CD output from the first learning model MD11. For example, when the learning of the first learning model MD11 progresses, the characteristics data CD included in the second training data TD21 is changed to the characteristics data CD output from the first learning model MD11.

A machine learning algorithm for generating the second learning model MD21 is similar to the machine learning algorithm for generating the learning model MD1 of the first embodiment. In the present embodiment, the machine learning algorithm for generating the second learning model MD21 is for example a neural network. That is, the second learning model MD21 includes the neural network.

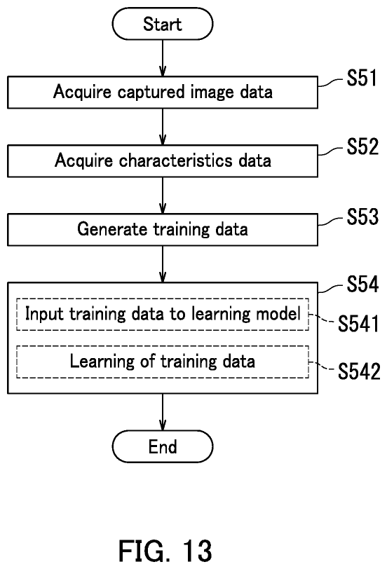

A process of causing the first learning model MD10 to learn the first training data TD11 will next be described with reference to FIG. 13. FIG. 13 is a flowchart depicting a first learning executed by the controller 230. The first learning process depicted in FIG. 13 includes Steps S51 to S54.

In Step S51, the controller 230 acquires the captured image data PD stored in the storage 250. The process then proceeds to Step S52.

In Step S52, the controller 230 acquires the characteristics data CD stored in the storage 250. The process then proceeds Step S53.

In Step S53, the first training data generating section 211 associates the captured image data PD with the characteristics data CD to generate the first training data TD11. The process then proceeds to Step S54.

In Step S54, the first learning section 212 inputs the first training data TD11 to the first learning model MD11 to cause the first learning model MD11 to learn the first training data TD11. Step S54 includes Step S541 and Step S542. In Step S541, the first learning section 212 inputs the first training data TD11 to the first learning model MD11. The process then proceeds to Step S542. In Step S542, the first learning model MD11 learns the input first training data TD11. The process then ends.

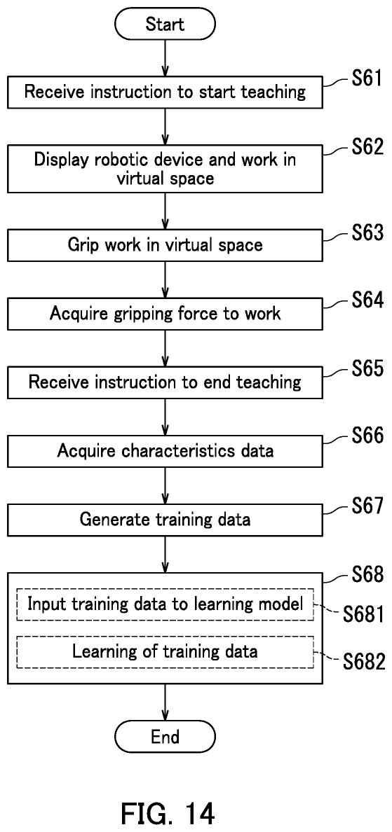

A process of causing the second learning model MD20 to learn the second training data TD21 will next be described with reference to FIG. 14. FIG. 14 is a flowchart depicting a second learning process executed by the controller 230. The second learning process depicted in FIG. 14 includes Steps S61 to S68. Steps S61 to S65 correspond to Steps S41 to S45 depicted in FIG. 7, respectively. Description of Steps S61 to S65 is therefore omitted.

In Step S66 after Step S65, the controller 230 acquires the characteristics data CD from the storage 250. The process then proceeds to Step S67.

In Step S67, the second training data generating section 221 generates the second training data TD21 in which the characteristics data CD is associated with the gripping force data GD. The process then proceeds to Step S68.

In Step S68, the second learning section 222 inputs the second training data TD21 to the second learning model MD20 to cause the second learning model MD20 to learn the second training data TD21. Specifically, Step S68 includes Step S681 and Step 5682. In Step 5681, the second learning section 222 inputs the second training data TD21 to the second learning model MD20. The process then proceeds to Step S682. In Step S682, the second learning model MD20 learns the input second training data TD21. The process then ends.

The embodiments of the present disclosure are described above with reference to the accompanying drawings. However, the present disclosure is not limited to the above embodiments and may be implemented in various manners within a scope not departing from the gist thereof. Furthermore, various disclosures may be created by appropriately combining elements of configuration disclosed in the above embodiments. For example, some of elements of configuration may be removed from all thereof disclosed in the embodiments. Furthermore, the constituent elements of different embodiments may be combined appropriately. The drawings illustrate main elements of configuration schematically to facilitate understanding thereof. Aspects of the elements of configuration such as thickness, length, numbers, or intervals illustrated in the drawings may differ in practice for the sake of convenience for drawing preparation. Furthermore, aspects such as speeds, materials, shapes, and dimensions of elements of configuration described in the above embodiments are merely examples and not particular limitations. Any elements of configuration may be variously altered within a scope not substantially departing from the configuration of the present disclosure.

(1) Although teaching of the robotic device 1 is performed in a virtual space in the first and third embodiments, the present disclosure is not limited to this. For example, the operator may directly operate the robotic device 1 to perform the teaching of the robotic device 1. For example, the operator directly operates the robotic device 1 to perform direct teaching thereof. The direct teaching means that the operator directly moves the robotic device 1 to perform settings of a position and posture of the robotic device 1.

(2) Although the learning model MD in the first embodiment learns the training data TD containing the captured image data PD and the gripping force data GD, the present disclosure is not limited to this. For example, the learning model MD may learn training data TD containing the captured image data PD, the gripping force data GD, and the characteristics data CD. In addition, the learning model MD1 trained, which has learned the training data TD containing the captured image data PD, the gripping force data GD, and the characteristics data CD receives the captured image data PD and the characteristics data CD, thereby outputting the gripping force data GD. The output gripping force data GD has precision increased by the captured image data PD and the characteristics data CD. Therefore, the gripping force for gripping the work W becomes a more appropriate value. It is consequently possible to appropriately grip the work W.

(3) Although the robot control device 3 in the third embodiment includes only the gripping controller 51, the present disclosure is not limited to this. The robot control device 3 in the third embodiment may further includes a first determination section 52, a second determination section 53, and an additional learning section 54.

What is claimed is:

1. A learning device comprising:
storage that stores therein a learning model; and
a learning section configured to cause the learning model to learn training data that includes captured image data and gripping force data, the captured image data corresponding to data to be input to the learning model, the gripping force data corresponding to data to be output from the learning model, wherein
the captured image data is data generated by capturing an image of a work that is a target to be gripped by a robotic device, and
the gripping force data is data indicating a gripping force of the robotic device when gripping the work.

2. The learning device according to claim 1, wherein
the gripping force data indicates a change over time in the gripping force.

3. The learning device according to claim 2, wherein
the gripping force indicates a change over time until the gripping force increases from an initial value and then becomes almost constant.

4. A robot control system comprising:
a robotic device; and
a robot control device, wherein
the robotic device includes a gripping section configured to grip a work,
the robot control device includes
an imaging section configured to capture an image of the work before the gripping section grips the work, and to generate captured image data representing the image of the work,
storage that stores therein a learning model trained, the learning model being generated by machine learning, and
a gripping controller configured to control the gripping section, the gripping controller
inputs the captured image data to the learning model to cause the learning model to output gripping force data, and
controls the gripping section so that the gripping section generates a gripping force that is indicated by the gripping force data output from the learning model, and
the gripping force data is data indicating the gripping force of the robotic device when gripping the work.

5. The robot control system according to claim 4, wherein
the imaging section captures an image of the gripping section in a gripping operation and the work in the gripping operation, and
the storage stores therein captured image data representing an image of the work when the gripping section has failed to grip the work, and the gripping force data indicating a gripping force of the gripping section when having failed to grip the work.

6. The robot control system according to claim 5, wherein
the robot control device further includes an additional learning section configured to cause the learning model to additionally learn the captured image data and corrected gripping force data, and
the corrected gripping force data is gripping force data corrected based on the captured image data representing the image of the work that has been failed to grip.

7. A learning control method comprising:
inputting training data to a learning model, the training data including captured image data and gripping force data, the captured image data corresponding to data to be input to the learning model, the gripping force data corresponding to data to be output from the learning model; and
causing the learning model to learn the training data, wherein
the captured image data is data generated by capturing an image of a work that is a target to be gripped by a robotic device, and
the gripping force data is data indicating a gripping force of the robotic device when gripping the work.
